(19) United States
(12) Patent Application Publication
(10) Pub. No.: US 2026/0346900 A1
(43) Pub. Date: Nov. 5, 2026

(54) LONGITUDINALLY ADJUSTABLE OPERATING UNIT AND STEER-BY-WIRE SYSTEM

(71) Applicant: Schaeffler Technologies AG & Co. KG, Herzogenaurach (DE)

(72) Inventors: Joseph Gissler, Friesenheim (DE); Sebastian Müller, Karlsruhe (DE); Benjamin Severin, Baiersbronn (DE)

(73) Assignee: Schaeffler Technologies AG & Co. KG, Herzogenaurach (DE)

(21) Appl. No.: 19/101,895

(22) PCT Filed: May 25, 2023
(86) PCT No.: PCT/DE2023/100392

§ 371 Date: Feb. 7, 2025

(30) Foreign Application Priority Data
Aug. 8, 2022 (DE) 10 2022 119 869.3

(51) Int. Cl. B62D 1/185; B62D 5/00

(52) U.S. Cl. CPC B62D 1/185; B62D 5/001

(57) ABSTRACT

The invention disclosure relates to a longitudinally adjustable operating unit including a telescopic pull-out device with an outer guide tube that guides an inner pull-out tube in a translationally displaceable manner. The pull-out device is coupled to a steering means and an actuation of the steering means causes a rotation of the outer guide tube or the inner pull-out tube. The pull-out device is coupled to a motor that applies a torque to the outer guide tube or the inner pull-out tube. The outer guide tube and the inner pull-out tube are supported in a torque-transmitting manner via a roller bearing arrangement so as to be translationally displaceable with respect to one another. The roller bearing arrangement has at least one bearing element with a cup-like receptacle formed in a main body. A first bearing ball and a group of second bearing balls are arranged in the cup-like receptacle.

### CROSS-REFERENCE TO RELATED APPLICATIONS

This application is the U.S. National Phase of PCT Application No. PCT/DE2023/100392 filed on May 25, 2023, which claims priority to DE 10 2022 119 869.3 filed on Aug. 8, 2022, the entire disclosures of which are incorporated by reference herein.

### TECHNICAL FIELD

The present disclosure relates to a longitudinally adjustable operating unit for influencing a driving direction of a motor vehicle by a user, in particular for use in a steer-by-wire system. The disclosure further relates to a steer-by-wire system.

### BACKGROUND

Electric steering devices are used-among other things in motor vehicles-to receive a driver's directional request and convert it into corresponding movements of one or more wheels. In contrast to purely mechanical steering devices, when it comes to electric steering devices, a distinction is made between electrically assisted steering devices and fully electric steering devices, so-called “steer-by-wire” steering devices. In particular, these steer-by-wire steering devices have the advantage that the operating unit can be positioned relatively freely within the vehicle, independent of mechanical connecting components, which, in addition to cost savings when distinguishing between, for example, right-and left-hand drive vehicles, also leads to improved accident behavior due to the absence of a steering column. Furthermore, the operating unit can be placed in a stowed position, which can also be used for fully automatic steering, for example.

A steer-by-wire steering system in the sense of the present disclosure is to be understood as a steering system, which substantially consists of a so-called hand wheel actuator (HWA), for example the actuator system around the commanding vehicle steering wheel, and a road wheel actuator (RWA), i.e., the actuator system acting on the steering mechanism connected to the vehicle wheels. The steering signal is transmitted from the HWA to the RWA by wire.

Such systems are generally known from the state of the art. For example, DE 10 2015 224 602 A1 discloses an adjustable steering column for a steer-by-wire steering assembly of a motor vehicle, which includes an actuating unit that has a steering spindle supported in a casing unit so as to be rotatable about a longitudinal axis. The casing unit has a first casing tube, in which at least one second casing tube is arranged in a rotationally fixed manner with respect to the longitudinal axis and is supported so as to be axially displaceable in a telescopic manner. An actuating drive is connected to the first and second casing tubes, by which the second casing tube can be axially extended and retracted relative to the first casing tube. The steer-by-wire steering assembly also includes a spindle drive with a threaded spindle arranged parallel to the longitudinal axis, which can be driven in rotation by an electric servomotor, which is supported on one casing tube and which is screwed into a spindle nut which is attached non-rotatably to the other casing tube. The threaded spindle extends within the first casing tube and the spindle nut is attached to the second casing tube.

DE 10 2018 212 696 B3 also discloses an adjusting drive for a motor-adjustable steering column for a motor vehicle, which includes a motor drive unit and an external threaded spindle, which has an external thread and a coaxial internal thread, into which an internal threaded spindle engages. The external threaded spindle and the internal threaded spindle can be driven by the drive unit to rotate relative to one another about an axis. In order to provide an adjusting drive that requires a lower drive torque and offers an optimized free adjustment path, DE 10 2018 212 696 B3 proposes that the external threaded spindle engages with a drive nut with its external thread, and the drive nut or the internal threaded spindle can be driven in rotation by the drive unit and is supported in the direction of the axis relative to the drive unit.

### SUMMARY

It is the object of the disclosure to provide an improved longitudinally adjustable operating unit for influencing a driving direction of a motor vehicle by a user, in particular for use in a steer-by-wire system. It is also the object of the disclosure to realize an improved steer-by-wire system.

The object is achieved by a longitudinally adjustable operating unit for influencing a driving direction of a motor vehicle by a user, in particular for use in a steer-by-wire system. The operating unit includes a telescopic pull-out device with an outer guide tube, in which an inner pull-out tube is guided in a translationally displaceable manner relative to the outer guide tube. The telescopic pull-out device is coupled on the one side to a steering means, and an actuation of the steering means representing a steering direction causes a rotation of the outer guide tube or of the inner pull-out tube. The telescopic pull-out device is coupled on the other side to a motor, by means of which a motor torque can be applied to the outer guide tube or the inner pull-out tube. The outer guide tube and the inner pull-out tube are supported in a torque-transmitting manner via a roller bearing arrangement so as to be translationally displaceable with respect to one another. The roller bearing arrangement has at least one first bearing element with a cup-like or cup-shaped receptacle formed in a main body, and the cup-like receptacle has a first bearing ball arranged in the cup-like receptacle and projecting out of the same, and has a group of second bearing balls arranged within the receptacle. A diameter of the first bearing ball is greater than a diameter of a respective second bearing ball of the group. The group of second bearing balls is arranged between the first bearing ball and the cup-like receptacle, such that the first bearing ball within the cup-like receptacle bears against the group of second bearing balls in a rolling manner. The first bearing ball projecting from the at least first bearing element engages in a rolling manner in a raceway extending axially through the outer guide tube or the inner pull-out tube, such that the outer guide tube and the inner pull-out tube are fixed to one another in the circumferential direction.

This has the advantage that a telescopic steering spindle with very low frictional resistance can be realized. Furthermore, the telescopic pull-out device has extremely low wear, which can be adjusted, for example, via a built-in spring element. Furthermore, the telescopic pull-out device is particularly unobtrusive acoustically. By spring-mounting the bodies, further damping is achieved at higher torques, and savings can be made in the dimensional accuracy of the raceways. Depending on the variant, this arrangement means that a raceway is only required in the tube or in the shaft.

The first bearing ball can in particular be formed from a metallic material. It is also possible that the first bearing ball is made of ceramic or has a ceramic coating.

The group of second bearing balls can also be formed from a metallic material. Alternatively, the second bearing balls may be made of a ceramic material. Furthermore, it is conceivable that the second bearing balls have a ceramic coating. In an example embodiment, the group of second bearing balls consists of substantially identical bearing balls.

The inner pull-out tube can be designed as a hollow shaft or a solid shaft. It is also conceivable that the inner pull-out tube is configured in sections as a hollow shaft and in sections as a solid shaft.

According to an example embodiment, it can be provided that the roller bearing arrangement has at least one second bearing element with a cup-like receptacle formed in a main body. The cup-like receptacle has a first bearing ball arranged in the cup-like receptacle and projecting out of the same, and has a group of second bearing balls arranged within the receptacle. A diameter of the first bearing ball is greater than a diameter of a respective second bearing ball of the group. The group of second bearing balls is arranged between the first bearing ball and the cup-like receptacle, such that the first bearing ball within the cup-like receptacle bears against the group of second bearing balls in a rolling manner. The first bearing ball projecting from the at least second bearing element engages in a rolling manner in a raceway extending axially through the outer guide tube or the inner pull-out tube, such that the outer guide tube and the inner pull-out tube are fixed to one another in the circumferential direction. The advantage of this design is that the low-friction bearing of the telescopic pull-out device can be further improved.

According to an example embodiment, it can also be provided that the roller bearing arrangement has at least one third bearing element with a cup-like receptacle formed in a main body. The cup-like receptacle has a first bearing ball arranged in the cup-like receptacle and projecting out of the same, and has a group of second bearing balls arranged within the receptacle. A diameter of the first bearing ball is greater than a diameter of a respective second bearing ball of the group. The group of second bearing balls is arranged between the first bearing ball and the cup-like receptacle, such that the first bearing ball within the cup-like receptacle bears against the group of second bearing balls in a rolling manner. The first bearing ball projecting from the at least third bearing element engages in a rolling manner in a raceway extending axially through the outer guide tube or the inner pull-out tube, such that the outer guide tube and the inner pull-out tube are fixed to one another in the circumferential direction. This makes it possible to provide a statically determined rolling bearing solely by the low-friction bearing elements.

Furthermore, according to an example embodiment, it can be provided that at least one of the raceways is designed as a groove into which one of the bearing balls engages. The advantageous effect of this embodiment is based on the fact that the raceways can be produced in a cost-effective manner, for example by broaching and/or rotary swaging.

According to an example embodiment, it can be provided that the groove has a trapezoidal cross-sectional contour, and the bearing ball bears against the non-parallel sides of the trapezoidal groove, which allows a good transmission of torques with good axial displaceability at the same time. In particular, the bearing ball then only has two point contacts on the non-parallel sides, which enables particularly low-friction and acoustically quiet operation of the telescopic pull-out device.

Furthermore, the disclosure can also be further developed in such a way that the first bearing element, the second bearing element and the third bearing element are substantially identical, whereby the component complexity and consequently also the costs can be reduced.

In an example embodiment, it can also be provided that the outer guide tube or the inner pull-out tube has at least one receptacle extending in the radial direction, in which one of the bearing elements is received. This makes it possible to ensure that the bearing elements can be inserted into the guide tube and/or pull-out tube and coupled to it in a simple and safe manner.

It may also be advantageous to further develop the disclosure in such a way that at least one of the bearing elements is biased in the radial direction by means of a spring element, such that the bearing ball bears against the raceway in a spring-loaded manner. The advantage that can be achieved in this way is that the telescopic pull-out device can be designed without play. Furthermore, this can also provide angle compensation and tolerance compensation. In an example embodiment, all bearing elements are each biased via a spring element.

According to an example embodiment, it can be provided that the spring element is supported on the one side against the main body of the bearing element and on the other side against the receptacle.

The object of the disclosure is further achieved by a steer-by-wire system for a motor vehicle comprising a longitudinally adjustable operating unit as described herein.

### BRIEF DESCRIPTION OF THE DRAWINGS

The disclosure will be explained in more detail below with reference to figures without limiting the general inventive concept.

In the figures:

FIG. 1 shows a longitudinally adjustable operating unit in an axial section,

FIG. 2 shows a first embodiment of a longitudinally adjustable operating unit in a cross-sectional view,

FIG. 3 shows a second embodiment of a longitudinally adjustable operating unit in a cross-sectional view,

FIG. 4 shows a detailed view of a bearing element in a cross-sectional view,

FIG. 5 shows a cropped detailed view of the first bearing ball of the bearing element in a perspective view,

FIG. 6 shows a telescopic pull-out device in a schematic axial section, and

FIG. 7 shows a motor vehicle with a steer-by-wire steering system in a schematic block diagram

### DETAILED DESCRIPTION

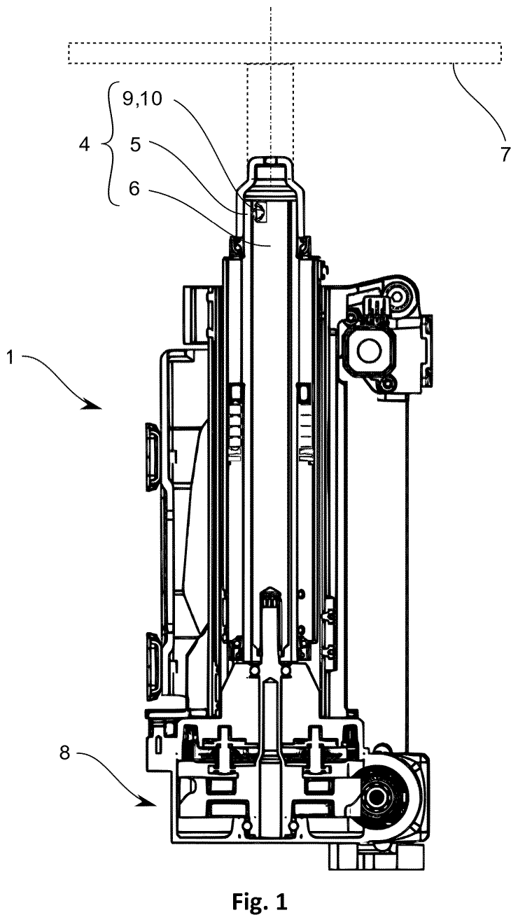

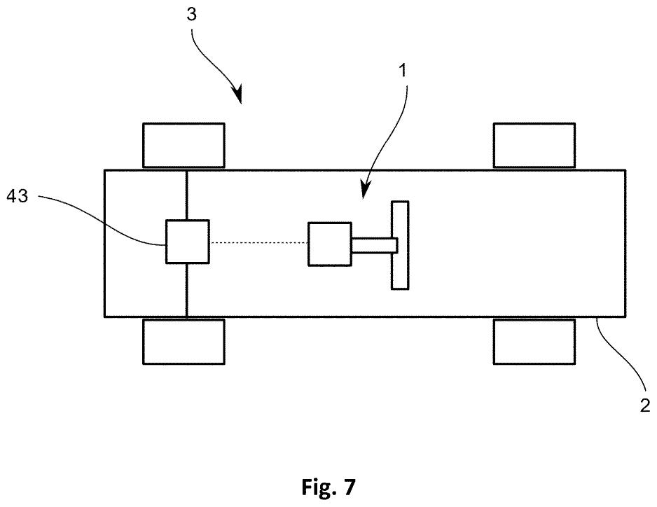

FIG. 1 shows a longitudinally adjustable operating unit 1 for influencing a driving direction of a motor vehicle 2 by a user, in particular for use in a steer-by-wire system 3, as is also outlined by way of example in FIG. 7.

The operating unit 1 comprises a telescopic pull-out device 4 with an outer guide tube 5, in which an inner pull-out tube 6 is guided in a translationally displaceable manner relative to the outer guide tube 5. The telescopic pull-out device 4 is coupled on the one side to a steering means 7, wherein an actuation of the steering means 7 representing a steering direction causes a rotation of the outer guide tube 5 or of the inner pull-out tube 6, and the telescopic pull-out device 4 is coupled on the other side to a motor 8, by means of which a motor torque can be applied to the outer guide tube 5 or the inner pull-out tube 6. In the design shown, the motor 8 serves as a force feedback actuator. In the illustrated exemplary embodiment, the steering means 7 is a steering wheel. In the outer guide tube 5, an end angle limiter is installed axially outward, which is supported on the casing tubes. Thus, “only” the torque of a force feedback actuator (FFA) has to be transmitted via the telescopic pull-out device 4.

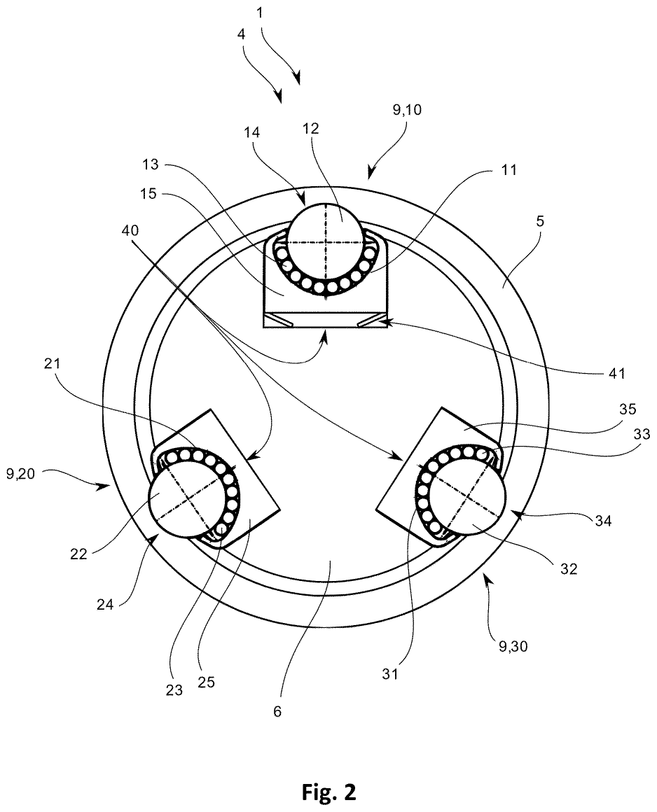

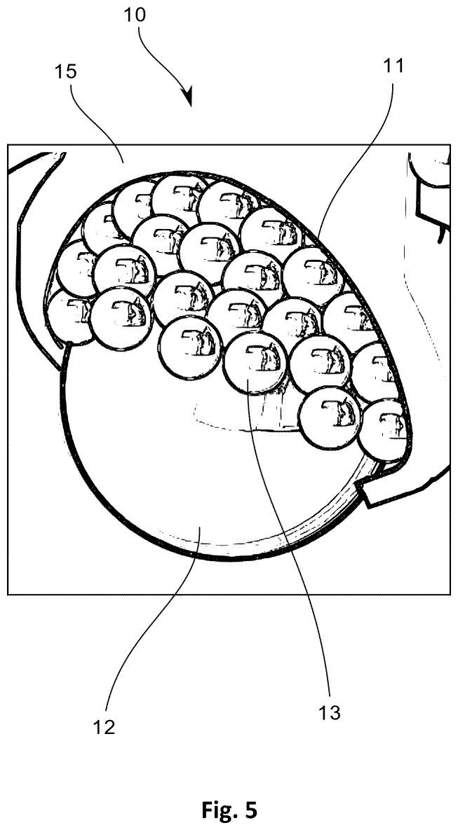

The outer guide tube 5 and the inner pull-out tube 6 are supported in a torque-transmitting manner via a roller bearing arrangement 9 so as to be translationally displaceable with respect to one another, wherein the roller bearing arrangement 9 has at least one first bearing element 10 with a cup-like (or cup-shaped) receptacle 11 formed in a main body 15, which cup-like receptacle has a first bearing ball 12 arranged in the cup-like receptacle 11 and projecting out of the same, and has a group of second bearing balls 13 arranged within the receptacle 11. This can be clearly seen in FIGS. 2-5.

The diameter of the first bearing ball 12 is larger than the diameter of a second bearing ball 13 of the group, wherein the group of second bearing balls 13 is arranged between the first bearing ball 12 and the cup-like receptacle 11, such that the first bearing ball 12 within the cup-like receptacle 11 bears against the group of second bearing balls 13 in a rolling manner.

The first bearing ball 12 projecting from the first bearing element 10 engages in a rolling manner in a raceway 14 extending axially through the outer guide tube 5 or the inner pull-out tube 6, such that the outer guide tube 5 and the inner pull-out tube 6 are fixed to one another in the circumferential direction. The first bearing ball 12 is held securely in the first bearing element 10, in that the opening diameter of the corresponding circular opening in the first bearing element 10 is smaller than the diameter of the first bearing ball 12.

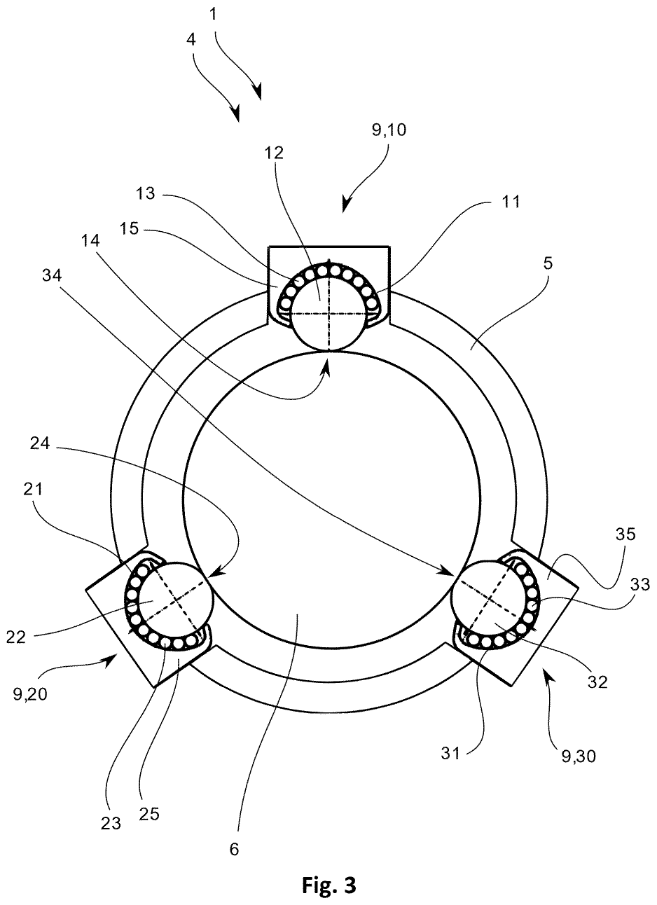

It can also be seen from FIG. 2 and FIG. 3 that the roller bearing arrangement 9 has one second bearing element 20 with a cup-like receptacle 21 formed in a main body 25, which cup-like receptacle has a first bearing ball 22 arranged in the cup-like receptacle 21 and projecting out of the same, and has a group of second bearing balls 23 arranged within the receptacle 21. Here too, the diameter of the first bearing ball 22 is larger than the diameter of a second bearing ball 23 of the group, wherein the group of second bearing balls 23 is arranged between the first bearing ball 22 and the cup-like receptacle 21, such that the first bearing ball 22 within the cup-like receptacle 21 bears against the group of second bearing balls 23 in a rolling manner. The first bearing ball 22 projecting from the at least second bearing element 20 engages in a rolling manner in a raceway 24 extending axially through the outer guide tube 5 or the inner pull-out tube 6, such that the outer guide tube 5 and the inner pull-out tube 6 are fixed to one another in the circumferential direction. The first bearing ball 22 is held securely in the second bearing element 20 due to the fact that the opening diameter of the corresponding circular opening in the second bearing element 20 is smaller than the diameter of the first bearing ball 22.

FIGS. 2-3 also clearly show that the roller bearing arrangement 9 has a third bearing element 30 with a cup-like receptacle 31 formed in a main body 35, which cup-like receptacle has a first bearing ball 32 arranged in the cup-like receptacle 31 and projecting out of the same, and has a group of second bearing balls 33 arranged within the receptacle 31. As with the other bearing elements 10, 20, the diameter of the first bearing ball 32 is greater than the diameter of a respective second bearing ball 33 of the group, wherein the group of second bearing balls 33 is arranged between the first bearing ball 32 and the cup-like receptacle 31, such that the first bearing ball 32 within the cup-like receptacle 31 bears against the group of second bearing balls 33 in a rolling manner. The first bearing ball 32 projecting from the third bearing element 30 engages in a rolling manner in a raceway 34 extending axially through the outer guide tube 5 or the inner pull-out tube 6 such that the outer guide tube 5 and the inner pull-out tube 6 are fixed to one another in the circumferential direction. The first bearing ball 32 is held securely in the third bearing element 30 due to the fact that the opening diameter of the corresponding circular opening in the third bearing element 30 is smaller than the diameter of the first bearing ball 32.

In FIGS. 2-3, it is further shown that the first bearing element 10, the second bearing element 20 and the third bearing element 30 are substantially identical.

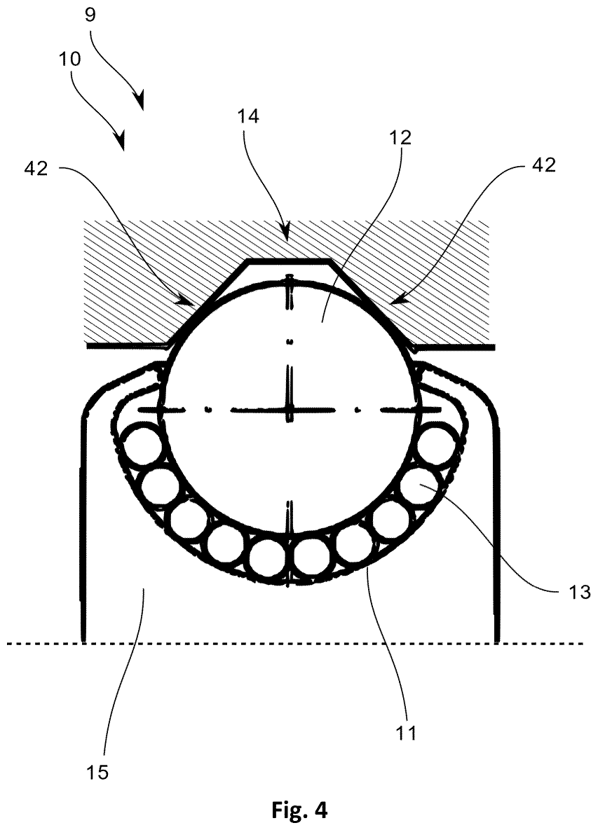

In the shown exemplary embodiments of FIGS. 2-3, the raceways 14, 24, 34 are each designed as a groove into which one of the bearing balls 12, 22, 32 correspondingly engages. FIG. 4 further shows that the groove has a trapezoidal cross-sectional contour, wherein the bearing ball 12, 22, 32 bears against the non-parallel sides 42 of the trapezoidal groove.

What can also be seen from FIGS. 2-3 is that the outer guide tube 5 or the inner pull-out tube (6) has in total three receptacles 40 extending in the radial direction, in which one of the bearing elements 10, 20, 30 is received.

In the embodiment of FIG. 2, the bearing elements 10, 20, 30 are arranged in the inner pull-out tube 6, wherein the bearing balls 12, 22, 32 then roll on the raceways 14, 24, 34 of the outer guide tube 5. In the embodiment of FIG. 3, the bearing elements 10, 20, 30 are arranged in the outer guide tube 5, wherein the bearing balls 12, 22, 32 roll here on the raceways 14, 24, 34 of the inner pull-out tube 6.

FIG. 2 also shows that one of the bearing elements 10 is biased in the radial direction by means of a spring element 41, such that the bearing ball 12 bears against the raceway 14 in a spring-loaded manner. The spring element 41 is supported on the one side on the main body 15 of the bearing element 10 and on the other side against the receptacle 40.

The spring element 41 can in particular be designed as a disc spring. The bearing elements 20 and 30 can also be biased by means of a spring.

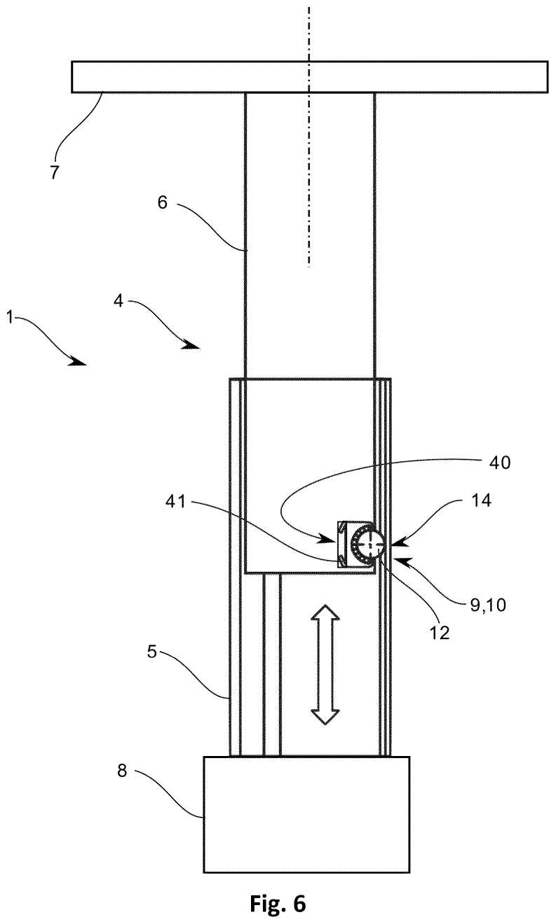

FIG. 6 shows the embodiment known from FIG. 2 in an axial sectional view. The outer guide tube 5 is connected to the motor 8, which is arranged in a fixed position with the guide tube 5 in the operating unit 1. In the outer guide tube 5, the inner pull-out tube 6 can then be displaced translationally by the roller bearing arrangement 9, so that the steering means 7 can be extended or retracted relative to the outer guide tube 5.

Finally, FIG. 7 shows a steer-by-wire system 3 for a motor vehicle 2 comprising a longitudinally adjustable operating unit 1, as is known for example from FIG. 1. By means of the operating unit 1, which can also be referred to as HWA—hand-wheel actuator, an RWA—road-wheel actuator 43 is then electrically controlled, which then converts the steering movement of the HWA to the vehicle wheels.

The disclosure is not limited to the embodiments shown in the figures. The above description is therefore not to be regarded as limiting but as illustrative.

### LIST OF REFERENCE SYMBOLS

1 Operating unit
2 Motor vehicle
3 Steer-by-wire system
4 Pull-out device
5 Guide tube
6 Pull-out tube
7 Steering means
8 Motor
9 Roller bearing arrangement
10 Bearing element
11 Receptacle
12 Bearing ball
13 Bearing balls
14 Raceway
15 Main body
20 Bearing element
21 Receptacle
22 Bearing ball
23 Bearing balls
24 Raceway
25 Main body
30 Bearing element
31 Receptacle
32 Bearing ball
33 Bearing balls
34 Raceway
35 Main body
40 Receptacle
41 Spring element
42 Sides
43 RWA

1. A longitudinally adjustable operating unit for adjusting a driving direction of a motor vehicle in a steer-by-wire system, comprising:
a telescopic pull-out device having an outer guide tube, in which an inner pull-out tube is axially guided relative to the outer guide tube, and
the telescopic pull-out device is coupled on a first side to a steering means, and an actuation of the steering means defining a steering direction causes a rotation of the outer guide tube or of the inner pull-out tube, and
the telescopic pull-out device is coupled on a second side to a motor, configured to apply a motor torque to the outer guide tube or the inner pull-out tube, and
the outer guide tube and the inner pull-out tube are supported via a roller bearing arrangement so as to be translationally displaceable with respect to one another, and the roller bearing arrangement has at least one first bearing element with a first cup-shaped receptacle formed in a main body of the at least one first bearing element, the at least one first bearing element having:
a first bearing ball arranged in the first cup-shaped receptacle and projecting out of the first cup-shaped receptacle, and
a first group of second bearing balls arranged within the first cup-shaped receptacle, and a diameter of the first bearing ball is greater than a diameter of a respective second bearing ball of the first group of second bearing balls, and the first group of second bearing balls is arranged between the first bearing ball and the first cup-shaped receptacle, such that the first bearing ball rolls against the first group of second bearing balls and the first bearing ball projecting from the first cup-shaped receptacle rollingly engages a first raceway extending axially through one of the outer guide tube or the inner pull-out tube such that the outer guide tube and the inner pull-out tube are fixed to one another in a circumferential direction.

2. The longitudinally adjustable operating unit according to claim 1, wherein the roller bearing arrangement further comprises at least one second bearing element having a second cup-shaped receptacle formed in a main body of the at least one second bearing element, and a first bearing ball arranged in the second cup-shaped receptacle and projecting out of the second cup-shaped receptacle, and the at least one second bearing element has a second group of second bearing balls arranged within the second cup-shaped receptacle, and a diameter of the first bearing ball of the at least one second bearing element is greater than a diameter of a respective second bearing ball of the second group of second bearing balls, wherein the second group of second bearing balls is arranged between the first bearing ball of the at least one second bearing element and the second cup-shaped receptacle such that the first bearing ball of the at least one second bearing element rolls against the second group of second bearing balls within the second cup-shaped receptacle and the first bearing ball projecting from the second cup-shaped receptacle rollingly engages a second raceway extending axially through one of the outer guide tube or the inner pull-out tube, such that the outer guide tube and the inner pull-out tube are fixed to one another in the circumferential direction.

3. The longitudinally adjustable operating unit according to claim 2, wherein the roller bearing arrangement further comprises at least one third bearing element with a third cup-shaped receptacle formed in a main body of the at least one third bearing element, the at least one third bearing element having:
a first bearing ball arranged in the third cup-shaped receptacle and projecting out of the third cup-shaped receptacle, and has
a third group of second bearing balls arranged within the third cup-shaped receptacle, and
a diameter of the first bearing ball of the third cup-shaped receptacle is greater than a diameter of a respective second bearing ball of the third group of second bearing balls, and
the third group of second bearing balls is arranged between the first bearing ball of the third cup-shaped receptacle and the third cup-shaped receptacle, such that the first bearing ball of the third cup-shaped receptacle rolls against the third group of second bearing balls and the first bearing ball projecting from the third cup-shaped receptacle rollingly engages in a third raceway extending axially through one of the outer guide tube or the inner pull-out tube, such that the outer guide tube and the inner pull-out tube are fixed to one another in the circumferential direction.

4. The longitudinally adjustable operating unit according to claim 3, wherein at least one of the first raceway, the second raceway, or the third raceway configured as a groove.

5. The longitudinally adjustable operating unit according to claim 4, wherein the groove has a trapezoidal cross-sectional contour, defined by non-parallel sides.

6. The longitudinally adjustable operating unit according to claim 3, wherein the at least one first bearing element, the at least one second bearing element, and the at least one third bearing element are substantially identical.

7. The longitudinally adjustable operating unit according to claim 3, wherein one of the outer guide tube or the inner pull-out tube has at least one receptacle extending in a radial direction, each of the at least one receptacle configured to receive a corresponding one of the at least one first bearing element, the at least one second bearing element, or the at least one third bearing element.

8. The longitudinally adjustable operating unit according to claim 1, wherein the at least one first bearing element is biased in a radial direction via a spring element, such that the first bearing ball springably rolls against the first raceway.

9. The longitudinally adjustable operating unit according to claim 8, wherein the spring element is supported on one side against the main body and on another side against the first cup-shaped receptacle.

10. A steer-by-wire system for a motor vehicle, comprising a longitudinally adjustable operating unit according to claim 1.

11. A longitudinally adjustable operating unit for adjusting a driving direction of a motor vehicle in a steer-by-wire system, comprising:
a telescopic pull-out device having:
an outer guide tube,
an inner pull-out tube disposed within the outer guide tube, and
the telescopic pull-out device configured to be coupled to a steering means and an electric motor, and
the outer guide tube and the inner pull-out tube are supported via a roller bearing arrangement so as to be axially displaceable with respect to one another, the roller bearing arrangement having a first ball secured to one of the inner pull-out tube or the outer guide tube in an axial direction such that during a telescoping motion of the telescopic pull-out device, the first ball rolls against and moves axially relative to a remaining one of the inner pull-out tube or the outer guide tube.

12. The longitudinally adjustable operating unit of claim 11, wherein the first ball rolls within a concave groove of the remaining one of the inner pull-out tube or the outer guide tube.

13. The longitudinally adjustable operating unit of claim 11, wherein the first ball is secured in a radial direction relative to the remaining one of the inner pull-out tube or the outer guide tube.

14. The longitudinally adjustable operating unit of claim 11, wherein the first ball is disposed within a first cup-shaped receptacle of the one of the inner pull-out tube or the outer guide tube.

15. The longitudinally adjustable operating unit of claim 14, further comprising a first group of second balls disposed within the first cup-shaped receptacle, and the first ball rollingly engages the first group of second balls.

16. The longitudinally adjustable operating unit of claim 14, wherein the first cup-shaped receptacle is constructed separately from the one of the inner pull-out tube or the outer guide tube.

17. The longitudinally adjustable operating unit of claim 16 wherein the first cup-shaped receptacle retains the first ball in an axial direction and in a radial direction relative to the one of the inner pull-out tube or the outer guide tube.

18. The longitudinally adjustable operating unit of claim 11, wherein the roller bearing arrangement further comprises a second ball:
secured to the one of the inner pull-out tube or the outer guide tube in the axial direction, and
arranged at a differential circumferential position than the first ball relative to the one of the inner pull-out tube or the outer guide tube.

19. The longitudinally adjustable operating unit of claim 18, wherein the roller bearing arrangement further comprises a third ball:
secured to the one of the inner pull-out tube or the outer guide tube in the axial direction, and
arranged at a differential circumferential position than the first ball and the second ball relative to the one of the inner pull-out tube or the outer guide tube.

20. The longitudinally adjustable operating unit of claim 19, wherein the first ball, the second ball, and the third ball each roll in a corresponding concave groove of the remaining one of the inner pull-out tube or the outer guide tube.
